(19) United States
(12) Patent Application Publication
(10) Pub. No.: US 2022/0355789 A1
(43) Pub. Date: Nov. 10, 2022

(54) METHOD AND DEVICE FOR STABILISING A TRACTION VEHICLE-TRAILER COMBINATION, AND CONTROL UNIT

(71) Applicant: ZF Friedrichshafen AG, Friedrichshafen (DE)

(72) Inventor: Stefan SCHMIDT, Osnabrück (DE)

(21) Appl. No.: 17/622,533

(22) PCT Filed: Mar. 5, 2020
(86) PCT No.: PCT/EP2020/055799

§ 371 Date: Dec. 23, 2021

(30) Foreign Application Priority Data
Jun. 27, 2019 (DE) 10 2019 209 380.9

(51) Int. Cl. B60W 30/045; B62D 7/15; B60T 8/24; B60T 8/17; B60W 10/18; B60W 10/20

(52) U.S. Cl. CPC B60W 30/045; B62D 7/159; B60T 8/248; B60T 8/1708; B60T 8/245; B60W 10/18; B60W 10/20; B60T 2201/04; B60T 2201/16; B60T 2270/30; B60W 2300/145

(57) ABSTRACT

A method is proposed for stabilizing a tractor-trailer combination comprising a tractor vehicle and a trailer. The tractor vehicle has front and rear axle steering. The distinguishing feature of the method is that while driving, and braking while rounding a curved trajectory, the steering angle of the wheels on the rear axle is set to be in the same direction as the steering angle of the wheels on the front axle in order to stabilize the tractor-trailer combination.

This application is a National Stage completion of International Application No. PCT/EP2020/055799 filed Mar. 5, 2020, which claims priority from German Patent Application Serial No. 10 2019 209 380.9 filed Jun. 27, 2019.

### FIELD OF THE INVENTION

The invention relates to a method and a device for stabilizing a tractor-trailer combination, and to a control unit for carrying out the method, according to the preambles of the independent claims.

### BACKGROUND OF THE INVENTION

A tractor-trailer combination consists of a tractor vehicle in the form of a conventional motor vehicle with two axles, with a towing hitch fixed on the motor vehicle, such that a trailer with its coupling is coupled to the towing hitch. A ball is provided at the end of the towing hitch, and the coupling of the trailer surrounds the said ball so as to allow rotation and pivoting. When driving off straight ahead, the tractor vehicle and the trailer have a common longitudinal axis. When driving round a curved trajectory, the coupling of the trailer rotates around the vertical axis of the ball of the towing hitch of the tractor vehicle, so that the longitudinal axes of the tractor vehicle and the trailer make an angle with one another, also called the articulation angle.

When a tractor-trailer combination is driving, it is known that braking around a curved trajectory can be problematic. If the loading and road conditions are unfavorable, it can happen that owing to the mass of the trailer which is to be decelerated in addition to the mass of the tractor vehicle, the rear of the tractor vehicle is pushed toward the outside of the curve. For example, the loading is unfavorable if the load is predominantly positioned along the sides and is not distributed approximately uniformly over the surface of the trailer. Furthermore, loading at the rear or along the sides is especially disadvantageous. This has particular effects with trailers that are unbraked or have overrunning brakes. During steady-state driving round a curved trajectory, a torque equilibrium is established around the vertical axis of the vehicle through the center of gravity. During braking, however, the axle load on the front axle increases whereas the axle load on the rear axle decreases. With braking forces substantially below the blocking limits, the lateral force at first decreases on the rear axle and increases on the front axle. If the steering wheel is held steady, the vehicle tends to turn into the curve. The path radius becomes smaller and a new equilibrium condition is produced. This happens by increasing the yaw rate and the sideslip angle. In extreme cases, no new equilibrium is established and the vehicle begins to oscillate or even skid.

From DE 10 2010 033 558 A1, a system for braking a trailer is known, wherein by means of an additional electric machine, which is part of the axle of the trailer, a braking effect on the wheels of the axle of the trailer is produced. Part of the disclosure of that publication includes further disclosures from the prior art, wherein by virtue of additional braking interventions at the axle of the trailer the driving during braking on a curved trajectory should be improved. A common feature of all the systems described is that additional equipment is required on the trailer. In other words, these methods cannot be used with conventional trailers.

### SUMMARY OF THE INVENTION

A purpose of the present invention is to stabilize the driving of a tractor-trailer combination round a curved trajectory while braking.

This objective is achieved by a method and a device for stabilizing a tractor-trailer combination. Furthermore, a control unit for carrying out the method is described. Starting from the preambles of the independent claims, the objective is achieved in combination with the respective characterizing features. The subsequent dependent claims, in each case, describe advantageous further developments of the invention. According to a first aspect of the invention, a method for stabilizing a tractor-trailer combination is indicated. The tractor-trailer combination comprises a tractor vehicle, i.e., the motor vehicle with a towing hitch arranged at the rear of the tractor vehicle. In addition, the tractor-trailer combination comprises a trailer which is articulated to the towing hitch of the tractor vehicle by way of a coupling arranged at the front end of the trailer. The towing hitch and the trailer coupling have a common rotation point which is located in the vertical axis of the ball of the towing hitch.

The distinguishing feature of the invention is that when braking while driving round a curved trajectory, a steering angle is set at the wheels of the rear axle which is in the same direction as the steering angle at the wheels of the front axle in order to stabilize the tractor-trailer combination. When the tractor vehicle decelerates, a braking action takes place. This can be initiated when the driver actuates the brakes of the tractor vehicle. Likewise other decelerations are conceivable, such as releasing the accelerator pedal or due to recuperation in the case of an electric drive. It is clear that the mass of the trailer will then also be decelerated. When driving round a curved trajectory there is an articulation angle between the tractor vehicle and the trailer, which is also known as the combination angle. Thus, the inertia of the trailer acts upon the tractor vehicle by way of the common rotation point. The inertia of the trailer acts as a force on the towing hitch and produces a torque around the vertical axis of the tractor vehicle. This torque brings about or reinforces the yaw torque of the tractor vehicle. The travel of the tractor-trailer combination round curves is thereby destabilized. This can result in lurching or oscillation, or in the worst case to skidding and breaking apart of the tractor-trailer combination. Particularly when the trailer is not braked, i.e., when it is not fitted with an overrun brake or an active brake system, this can lead to an uncontrollable driving condition of the tractor-trailer combination. An inexperienced driver can easily be overstressed by that situation. This is especially so if the road condition is poor, for example, when the road is very wet by rain, or icy, or even if the friction coefficients of the vehicle's wheels are different. The latter can be the case, for example, if the vehicle or trailer is still driving on the road with its wheels on the left but with the wheels on the right it is driving on an unmade surface, such as the verges.

In summary, it can be said that the objective is achieved in that with a tractor-trailer combination that is braked while driving round a curved trajectory, a steering angle is set in the tractor vehicle at the rear axle which is in the same direction as, or at least not in an opposite direction relative to the steering angle at the front axle. The steering angle in the same direction is thus, in particular, also set in a low speed range in which the rear axle steering would usually be set in an opposite direction. Namely, at low speeds, for example below 50 km/h, steering in opposite directions is set in order to make the vehicle more agile (the vehicle becomes more maneuverable). Otherwise than, for example, during a turning maneuver to the left when only the front axle can be actuated to the maximum extent, a minimized turning maneuver can be carried out with rear axle steering if the rear axle wheels are steered as far as possible in the opposite direction. In other words, the turning radius of the vehicle is thereby minimized.

However, the opposite steering angle results in an increase of the yaw torque of the vehicle. In turn, in the case of braking while driving round a curved trajectory, particularly with a trailer having no brakes or overrunning brakes, this would lead to a further destabilization of the movement of the tractor-trailer combination. But with a steering angle in the same direction at the rear axle, the yaw torque of the vehicle is reduced and the tractor-trailer combination is therefore stabilized. The reason for this is that when the steering angles at the rear and front axles are in the same direction, the instantaneous center of rotation of the tractor vehicle is always behind the rear axle. This has the positive result that a stabilizing effect is produced or maintained.

In this case, the method can be developed such that when the customary unbraked trailer is coupled, the control of the rear axle steering, which is preferably in the form of a steer-by-wire steering system, signals this trailer operation mode. In that way, independently of the speed at the time, i.e., even when traveling slowly, a steering angle of the rear axle can be set in the same direction. However, in order to achieve a turning radius as small as possible, it is alternatively possible for the driver of the tractor vehicle to choose, while in the driver's cabin, between the operating modes of minimum turning radius and braking while driving round a curved trajectory.

The rear axle steering of the tractor vehicle is preferably a steer-by-wire steering system. In other words, there is no mechanical connection to the steering device, i.e., the steering wheel of the vehicle with which the driver actuates the front axle steering. The rear axle steering system brings about a change of the wheel steering angle at the rear axle. This change is determined as a function of the wheel steering angle set at the front axle as well as other parameters, such as the acceleration of the vehicle, the speed of the vehicle and the current yaw rate of the vehicle, and other variables.

In a preferred embodiment the yaw rate of the tractor vehicle during the operation of the tractor-trailer combination is monitored, at least at intervals, in order that if an instability of the tractor-trailer combination is recognized, at least a steering angle in the same direction as the front axle can be set at the rear axle. Nowadays, vehicles are, as a rule, equipped with a so-termed ESP. This is a so-termed Electronic Stability Program which, among other things, detects the yaw rate of the vehicle about its vertical axis by means of a suitable sensor system. In that way, the yaw rate and yaw torque at the tractor vehicle can be determined. If the said yaw rate or yaw torque increase during driving round a curved trajectory while braking, then clearly a destabilization of the tractor-trailer combination while driving round the curve is imminent or already taking place. If a suitable control unit is available, the requisite wheel steering angle at the rear axle, in the sense of a steering angle in the same direction as at the front, can be set.

Preferably, the braked drive round a curve is determined by evaluating acceleration sensors present in the vehicle and/or by means for the recognition of a braking process at least at one wheel of the tractor vehicle and/or the trailer. Suitable acceleration sensors are present, for example, in control units such as the ESP control unit. Likewise, such sensors can be built into the chassis of the vehicle. The said means for recognizing a braking process can be, for example, sensors on the pedalry, so that the wish for braking or the actual act of braking by the vehicle driver can be sensed. In addition, sensors can be fitted on the brake actuators. In a suitable control unit, the characteristic of the tractor vehicle when braking can be stored. During trailer operation, by coupling to the trailer it is indicated to the control unit that operation of the tractor-trailer combination is now under way. The inertia of a trailer brings about a change of the braked drive round a curved trajectory. As mentioned earlier, this also depends on the loading condition of the trailer. Clearly, during trailer operation, i.e., when the trailer is coupled, accelerations different from those in the normal condition of the tractor vehicle will exist and can be sensed.

Reference has already been made to the minimizing of the turning radius while driving slowly, in particular driving very slowly, for a turning maneuver. To carry out the method, however, i.e., to stabilize the tractor-trailer combination, the steering angle at the rear should not be in the opposite direction. In order to reduce the turning radius even with a same-direction steering angle at the rear axle, during the braked cornering operation, as a function of the speed at the time, the turning radius is reduced by increasing the wheel steering angle at the front axle, in particular to its maximum extent. There is, therefore, still a steering angle in the same direction at the front and rear axles. For this to be made possible independently of an actuation of the steering wheel by the driver of the vehicle, for example at the front axle a so-termed superposition steering can be used. With a superposition steering, an additional actuator is arranged on the steering transmission. This additional actuator can change the wheel steering angle set by the driver by means of the steering wheel. In that case, advantageously the wheel steering angle at the front axle is increased by the superposition steering so that the turning radius is reduced as much as possible. Depending on the steering angle at the rear axle, to stabilize the tractor-trailer combination the steering angle at the rear axle can be changed in such a manner that although the steering angles at the front and rear axles are still in the same direction, the turning radius is further minimized. Thus, the stabilizing effect still exists.

In a further example embodiment, the method can also be used with a tractor-trailer combination that is driving downhill. This is also possible while driving round a curved trajectory without braking. The reason for this is that when driving downhill round a curve, owing to the inclined surface a sideways thrust on the trailer is produced due to gravity. This is similar to the effect of cornering with braking on a level road, when the trailer is unbraked or only has overrunning brakes in the direction of the tractor vehicle. The advantages of the stabilizing effect of the method can thus also be used when the tractor-trailer combination is driving downhill round a curved trajectory.

In a particular embodiment, when a parking process is recognized the method is interrupted until parking has been completed, so that oppositely directed steering angles at the front and rear axles are acceptable. During a parking process, the maximum possible maneuverability is desirable. Using the maximum possible steering angle at the front and rear axles and the smallest possible turning circle by virtue of oppositely directed steering angles, a vehicle can be parked more efficiently.

According to a further aspect, the invention relates to a control unit for a tractor vehicle, for carrying out the method according to any of the described embodiments. In this case, a separate control unit can be present in a motor vehicle exclusively for stabilizing the operation of the tractor-trailer combination. Alternatively, the method can also be carried out with a control unit already present in the vehicle, preferably an ESP control unit. Furthermore, an existing ESP control unit and a separate control unit can share partial functions or supplement the carrying out of the method.

The above-mentioned control units can be connected to sensors, so that as a function of sensor parameters read out by the control unit, a braked drive round a curved trajectory and/or an unbraked or braked downhill trajectory can be recognized. The sensors are preferably connected to the control unit by way of a vehicle bus system. Preferably, this is a CAN bus system. The sensors are preferably designed to be on the wheels of the tractor vehicle to evaluate the wheel steering angle and/or in the tractor vehicle to evaluate its speed and/or to evaluate the yaw torque of the tractor vehicle and/or to evaluate the braking process of the tractor vehicle and/or the trailer. To evaluate the behavior of the trailer, sensors can be present on the tractor vehicle which recognize the oscillating movement of the trailer. This can be made possible, for example, by optical sensors on the rear of the tractor vehicle. Moreover, the movement of the coupling relative to the coupling ball can be sensed, in particular, by means of a no-contact sensor system, preferably by a sensor system that works inductively.

In a further aspect the invention relates to a device for stabilizing a tractor-trailer combination. The said device is preferably part of the tractor vehicle and can be used with a tractor-trailer combination that comprises a tractor vehicle and a trailer, such that at least the tractor vehicle can be steered at its front and rear axles and comprises a control unit as described above. The distinguishing feature of the device is that while driving round a curved trajectory without braking and/or while driving downhill, steering angles in the same direction can be set at the wheels of the rear axle of the tractor vehicle and at the wheels of the front axle, in order to stabilize the tractor-trailer combination. The stabilizing steering angle at the rear axle is then set as a function of the parameters evaluated by the control unit, as mentioned earlier.

As outlined at the beginning in relation to the method, the invention is intended, in particular, to enable conventional, unbraked trailers or only overrunning brake trailers to be used. It is not excluded, however, that trailers with active braking systems or steering systems at the wheels can also be operated with the method. Even actively braked or articulated trailers can be inappropriately loaded, so that destabilization can occur quite soon during a braked curved trajectory. It is also conceivable that the active actuators on the trailer fail, for example due to an electrical fault, so that a trailer that can actually be operated actively will behave as a conventional, unbraked trailer in the event of a fault.

Preferably, the stabilizing same-direction steering angle at the rear axle can be adjusted as a function of the parameters evaluated by the control unit, so that the stabilizing same-direction steering angle takes into account the actually existing driving condition of the tractor-trailer combination.

Preferably, the steering system at both the front axle and the rear axle is in the form of steer-by-wire steering. As already mentioned, if at the front axle a larger steering angle has to be set than that intended by the driver of the vehicle, then a corresponding control unit can set a larger steering angle at the front axle as necessary. Thus, there is no need for a superposition steering system at the front axle, and this has cost advantages. With such a device a tractor-trailer combination can be stabilized in an advantageous manner.

### BRIEF DESCRIPTION OF THE DRAWING

Below, the invention will be described with reference to a preferred embodiment, having regard to the drawing.

FIG. 1 shows a view of a tractor-trailer combination, seen from above.

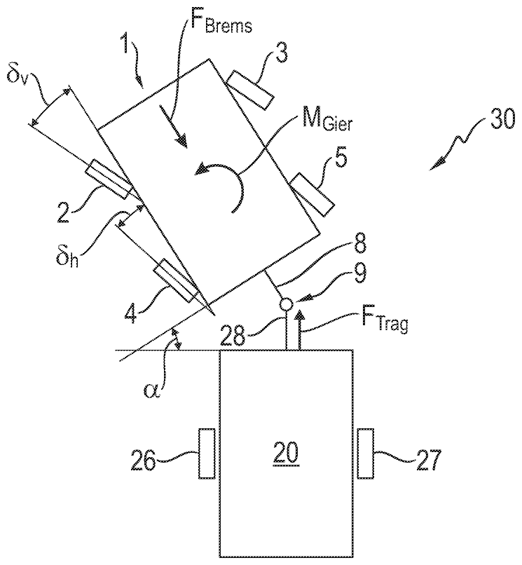

### DETAILED DESCRIPTION OF THE PREFERRED EMBODIMENT(S)

The single FIGURE shows a schematic view from above, of a tractor vehicle 1 and a trailer 20. The tractor vehicle 1 has a front axle with wheels 2 and 3. In addition, a rear axle is shown with wheels 4 and 5. A towing hitch 8 is attached at the rear of the vehicle. A coupling ball 9 is arranged at the end of the towing hitch 8.

The trailer 20 has a trailer axle with wheels 26 and 27. A trailer coupling 28 is arranged at the front of the trailer. The trailer 20 is coupled to the tractor vehicle 1, in that the coupling 28 is rotatably fitted onto the coupling ball 9 of the towing hitch 8 in the usual manner. The indicated angle α shows the combination angle, also called the articulation angle.

The tractor-trailer combination 30 is being braked while driving round a curved trajectory. In order to drive round the curve, a wheel steering angle δᵥ to the left is set at the front wheels 2 and 3. A wheel steering angle δₕ in the same direction, namely to the left, is set at the rear wheels 4 and 5. The tractor vehicle is decelerated by a braking force F_{Brems}, so braked cornering is initiated and carried out. Owing to the deceleration of the tractor vehicle 1 by the braking process, the trailer 20 moves in the direction of the rear of the tractor vehicle, so that the force denoted by F_{Trag} acts upon the common pivot point at the coupling ball. This increases the yaw torque M_{Gier} of the tractor vehicle about its vertical axis. By virtue of the steering angles in the same direction shown on the tractor vehicle, the tractor-trailer combination 30 is stabilized. Accordingly, the tractor vehicle or the trailer do not break apart and the intended trajectory of the curve to the left can be maintained.

The invention does not relate solely to passenger motor vehicles but is also appropriate for tractor-trailer combinations in the utility vehicle sector. Likewise, trailers with more than one axle can be used.

### INDEXES

1 Tractor vehicle
2, 3 Front axle wheels
4, 5 Rear axle wheels
8 Towing hitch
9 Towing ball
20 Trailer
26, 27 Trailer axle wheels
28 Trailer coupling
30 Tractor-trailer combination
M_{Gier} Tractor vehicle yaw torque
F_{Brems} Tractor vehicle braking force
F_{Trag} Trailer inertia force
α Combination angle, articulation angle
δᵥ Wheel steering angle, front axle
δₕ Wheel steering angle, rear axle

1-11. (canceled)

12. A method for stabilizing a tractor-trailer combination (30) comprising a tractor vehicle (1) and a trailer (20), wherein the tractor vehicle (1) has a steerable axle and a steerable rear axle, and the method comprising:
when braking the tractor-trailer combination (30) while driving round a curved trajectory, setting a steering angle for wheels (4, 5) of the rear axle at a same direction as a steering angle of wheels (2, 3) of the front axle in order to stabilize the tractor-trailer combination (30).

13. The method according to claim 12, further comprising, during the operation of the tractor-trailer combination, monitoring a yaw torque (M_{Gier}) of the tractor vehicle (1), at least at intervals, in order to produce the steering angle in the same direction at the rear axle in the event of instability of the tractor-trailer combination (30).

14. The method according to claim 12, further comprising determining the braked curved trajectory by at least one of:
acceleration sensors present in the tractor vehicle (1), and/or
recognizing a braking process at least at one wheel of the tractor vehicle (1) and/or the trailer (20).

15. The method according to claim 12, further comprising, during the braked curved trajectory, increasing the wheel steering angle (α) at the front axle, as a function of the speed at the time, in order to reduce a turning radius.

16. The method according to claim 12, further comprising using the method with the tractor-trailer combination (30) when driving downhill, even while driving unbraked round a curved trajectory.

17. The method according to claim 12, further comprising, when a parking process is recognized, interrupting the method until completion of the parking process so that steering angles, in opposite directions at the front and rear axles, are permitted in order to provide maximum maneuverability during the parking process.

18. A control unit for a tractor vehicle (1) for carrying out the method according to claim 12, such that the method can be carried out using the control unit for stabilization.

19. The control unit according to claim 18, wherein the method is carried out at least in part using a control unit already present in the vehicle.

20. The control unit according to claim 19, wherein the control unit already present in the vehicle is an ESP control unit.

21. The control unit according to claim 18, wherein the method is carried out, at least in part, using an ESP control unit already present in the vehicle, wherein the ESP control unit is connected at least to sensors, by way of a vehicle bus system, in order to evaluate:
the wheel steering angle of the wheels of the tractor vehicle (1), and/or
a speed of the tractor vehicle (1), and/or
a behavior of the trailer, and/or
a yaw torque of the tractor vehicle (1), and/or
a braking process at the tractor vehicle (1) and/or at the trailer (20), so that, as a function of the sensor parameters, a braked curved trajectory and/or unbraked or braked driving downhill can be recognized.

22. A device for stabilizing a tractor-trailer combination (30), such that at least the tractor vehicle (1) can be steered at its front and rear axles and comprises at least one control unit according to claim 18, wherein, driving unbraked round a curved trajectory and/or when driving downhill, the wheels (4, 5) on the rear axle of the tractor vehicle (1) are set at a steering angle which is in the same direction as the wheels (2, 3) on the front axle in order to stabilize the tractor-trailer combination (30).

23. The device according to claim 22, wherein the stabilizing steering angle, at the rear axle, is adjusted as a function of the parameters evaluated by the control unit.

24. The device according to claim 23, wherein at least one of the steering at the front axle and/or the rear axle is in a form of a steer-by-wire steering system.
